(19) United States
(12) Patent Application Publication
(10) Pub. No.: US 2025/0006409 A1
(43) Pub. Date: Jan. 2, 2025

(54) GELS COMPRISING SUPRAMOLECULAR NANOTUBES OF SINGLE-CHAIN MAGNETS

(71) Applicants: INSTITUT NATIONAL DES SCIENCES APPLIQUÉES DE RENNES, RENNES (FR); UNIVERSITÀ DEGLI STUDI DI FIRENZE-UNIFI, FIRENZE (IT); UNIVERSITE DE RENNES, RENNES (FR); CENTRE NATIONAL DE LA RECHERCHE SCIENTIFIQUE, PARIS (FR); ECOLE NATIONALE SUPÉRIEURE DE CHIMIE, RENNES (FR)

(72) Inventors: Félix HOUARD, RENNES (FR); Kevin BERNOT, RENNES (FR); Matteo MANNINI, FIRENZE (IT); Giuseppe CUCINOTTA, FIRENZE (IT)

(21) Appl. No.: 18/692,631

(22) PCT Filed: Aug. 22, 2022
(86) PCT No.: PCT/FR2022/051600

§ 371 Date: Mar. 15, 2024

(30) Foreign Application Priority Data
Sep. 17, 2021 (FR) 2109779

(51) Int. Cl. H01F 1/00; C07F 5/00

(52) U.S. Cl. CPC H01F 1/0036; C07F 5/003

(57) ABSTRACT

The invention relates to a supramolecular nanotube comprising at least one single-chain magnet including a coordination polymer, said coordination polymer comprising at least one linear macromolecular chain comprising repeating units containing at least one metal, said metal being coordinated by at least one ligand comprising at least one linear carbon chain, said linear carbon chain comprising more than 5 carbons, preferably the linear carbon chain comprises 6 to 30 carbons.

The present invention relates to the field of single-chain magnets and more particularly relates to supramolecular nanotubes of single-chain magnets, and to the preparation thereof in the form of supramolecular metallogels, as well as to the use of such supramolecular metallogels for information storage.

### STATE OF THE ART

Supramolecular chemistry is a branch of chemistry that is based on non-covalent or weak interactions between atoms within a molecule or between molecules within a molecular assembly. Also, supramolecular gels are defined as being gels wherein the molecules that make them up interact with each another by non-covalent bonds. Metallogels are materials belonging to the category of supramolecular gels including at least one metal. The preparation of such a metallogel involves at least one coordination polymer containing an organic part (ligand) consisting of one or more carbon chain(s) or an aromatic ring which may contain heteroatoms (such as O, N, S, F, etc.) and one or more metal ion(s); each metal ion establishing one or more coordination bond(s) with the ligands [ref. 1]. The metal ions and the ligands may also grant the material physicochemical properties, linked to their intrinsic properties of luminescence, electrical conductivity, magnetism, etc. [ref. 2-5].

In addition, the use of elements from the f-block of the periodic table, in particular the lanthanides, is known for manufacturing supramolecular gels. These lanthanide-based gels are mostly used for obtaining soft materials with luminescent features, by virtue of the characteristic optical properties of these ions of the 4f series [ref. 6-15].

However, the above-mentioned supramolecular gels, manufactured based on lanthanide salts, do not have the ideal magnetic or structural properties for their integration into information storage devices.

The use of supramolecular nanotubes of single-chain magnets having an open magnetic hysteresis curve that is suitable for information storage applications is known [ref. 16], but these nanotubes of the state of the art are only obtained in crystalline form, making it difficult, or even impossible in this case, to deposit them on a surface.

### DESCRIPTION OF THE INVENTION

The present invention relates to a supramolecular material with ideal hysteresis curves for information storage that is particularly easy to integrate into an information storage device.

To this end, the present invention relates to a supramolecular nanotube comprising at least one single-chain magnet including a coordination polymer, said coordination polymer comprising at least one linear macromolecular chain including repeating units containing at least one metal, the metal being coordinated, i.e. bonded via at least one coordination bond, for example of the ionic or covalent type, by at least one ligand comprising at least one linear carbon chain comprising more than 5 carbons, the linear carbon chain preferably comprising 6 to 30 carbons, said linear carbon chain advantageously comprising 9 to 27 carbons, or 12 to 24 carbons. The inventors have demonstrated, entirely unexpectedly, that the presence of such linear carbon chains, due to their intrinsic properties as an aliphatic chain, makes it possible to obtain nanotubes that are correctly shaped for preparing gels, in particular metallogels, that can be easily deposited on a solid support. The inventors have succeeded in preparing supramolecular materials in the form of a gel, and have demonstrated, entirely by accident, that unlike crystals, such supramolecular materials in the form of gels, and in particular the metallogels, make it possible to deposit the supramolecular material on a solid surface with a view to manufacturing an information storage device.

In the context of the present invention, the terms “nanotube” and more particularly “supramolecular nanotube” refer to a tube with a diameter of the order of one nanometer formed by the helical arrangement of one-dimensional coordination polymers interacting with each another by weak bonds.

In the context of the present invention the term “single-chain magnet” refers to a one-dimensional coordination polymer having magnetic properties confined within said coordination polymer. The single-chain magnet adopts a magnetic relaxation governed by the growth of a magnetic correlation length along the chain.

The term “coordination polymer” in the context of the invention qualifies an inorganic or organometallic polymeric structure comprising metal centers that are interconnected by organic ligands. A coordination polymer may also be defined as a coordination compound with repetition of coordination units, qualified as metal-ligand-type repeating units, extending in one, two or three dimensions through coordination bonds (IUPAC definition).

The term “metal” in the context of the present invention refers either to an uncharged metal atom when the chemical element has an oxidation state of zero, or to a negatively or positively charged metal ion when the chemical element has an oxidation state other than zero.

The metal integrated in the linear macromolecular chain is preferably a chemical element selected from the transition metal family.

The term “transition metal” qualifies the elements from the d-block of the periodic table, and the family of the lanthanides and actinides which belong to the elements from the f-block of the periodic table. The inventors have shown that these chemical elements are the best candidates for the formation of supramolecular nanotubes according to the invention.

By virtue of such supramolecular nanotubes, the development of materials and processes compatible with the deposition of supramolecular materials in the form of nanotubes on a solid substrate is made possible. It is shown that the elongation of the length of the aliphatic chain of the organic ligand makes it possible to control the formation of the gel, and therefore promotes the formation of a metallogel, in particular in the presence of a linear-chain aliphatic solvent. The carbon chains, and more particularly the linear carbon chains, promote the interchain weak interactions in the supramolecular material through low energy bonds, for example by the formation of bonds implementing Van der Waals interactions. The inventors have demonstrated, entirely unexpectedly, that the length of the aliphatic carbon chains is a determining parameter for the formation of the supramolecular nanotube. Linear chains that are too small, integrating less than 5 carbons, do not make it possible to obtain a configuration in the form of a nanotube. Conversely, chains with more than 15 carbon atoms give access to the best formed nanotubes, and give access to the manufacture of metallogels having physicochemical characteristics that are compatible with a use for data storage (information storage). However, the use of chains of excessive length is not desired, given that the steric hindrance becomes too great for an interchain association compatible with the nanotube-type configuration.

Advantageously, the metal of the linear macromolecular chain is selected from at least one of the seventeen elements belonging to the rare earth family, i.e. selected from Sc, Y, Lu, La, Ce, Pr, Nd, Pm, Sm, Eu, Gd, Tb, Dy, Ho, Er, Tm and Yb, preferably terbium Tb. Rare earth metals, and in particular terbium, integrated into single-chain magnets have advantageous magnetic properties, with a slow relaxation of the magnetization. Advantageously, the supramolecular nanotube according to the invention includes at least seven single-chain magnets, preferably the supramolecular nanotube includes at least ten single-chain magnets. The inventors have demonstrated, entirely by accident, that the number of associated single-chain magnets was a parameter of the highest order for controlling the obtaining of a configuration of a molecular assembly in the form of nanotubes.

Advantageously, at least one ligand of the single-chain magnet comprises a radical group. Such a radical ligand advantageously has the radical on a nitrogen heteroatom, and is qualified as an N-radical ligand, or on an oxygen heteroatom and is qualified as an 0-radical ligand. Preferably, the radical ligand is an O-radical ligand of the nitroxide type, i.e. a ligand wherein part of the backbone is a nitroxide denoted NO, which can be represented in the following manner:

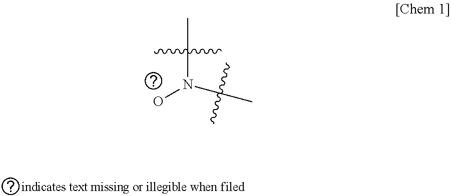 [SMILES: *N(*)O]

Such nitroxide-type radical ligands can be monodentate such as the TEMPO ligand [ref. 26], bidentate such as the 2pyNO ligand [ref 27], or tridentate such as the 6pyNO ligand [ref. 28]. Preferably, the radical ligand comprises the nitronyl-nitroxide radical referred to as NIT. The nitronyl-nitroxide radical has the following chemical formula:

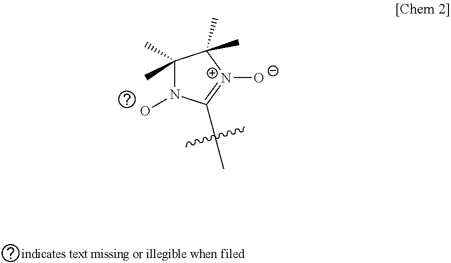

The coordinated NIT ligand, with the metals, and in particular the lanthanides, makes it possible to obtain magnetic relaxation curves that have the expected characteristics for the sought applications in information storage [ref. 25]. NIT also has the advantage of being able to finely control the shaping [ref. 17-19] of the single-chain magnets which may, in a non-limiting manner, assemble to form annular assemblies, chains of larger dimensions, supramolecular nanotubes forming chiral helices [ref. 16], associating them with ad hoc chemical functions.

Advantageously, the ligand of the supramolecular nanotube according to the invention includes an aromatic group substituted by the linear carbon chain and by an NIT radical, preferably the aromatic group is a phenoxy group (PhO—). The aromatic groups make it possible to engage non-covalent interactions of the π-stacking type and stabilize the structures of the single-chain magnets by virtue of the stacking of several groups in the same chain.

The present invention also relates to a metallogel including a gel comprising supramolecular nanotubes as presented hereinbefore in the context of the invention, wherein the nanotubes comprise molecules of an apolar aprotic organic solvent, preferably a linear aliphatic solvent, the solvent preferably being selected from at least n-hexane, n-heptane, n-octane and n-decane, preferably n-heptane. n-heptane is preferred, the inventors having observed by accident that it makes it possible to obtain an identical gelation process, in particular under the same conditions and the same concentrations, for all the metallogels that have been studied, independently of the length of the carbon chain of the ligands coordinated with the metal ion. The interaction of the linear carbon chains with the apolar solvent molecules appears to further induce the formation of the supramolecular nanotube, i.e. the interactions between these various partners appears to lead more easily to the spatial shaping in the form of nanotubes. Preferably, the gel is obtained from a solution comprising the supramolecular nanotubes dissolved in the apolar aprotic solvent optionally by means of heating to obtain total dissolution; then the solution must be cooled until reaching a temperature of between 0 and 5° C., which is maintained for at least one minute, before allowing the mixture to return to room temperature.

The present invention also relates to an information storage material comprising a substrate covered with a metallogel as described hereinbefore in the context of the invention. The substrate is preferably a silicon substrate; however, it may be any type of amorphous or crystalline, magnetic or non-magnetic, conductive or insulating material. Such a metallogel system deposited on a substrate makes it possible to achieve considerably greater information storage capacities than those achieved in prior technologies.

The present invention also relates to a method for manufacturing the information storage material as described hereinbefore in the context of the invention, including a step of depositing the metallogel on the substrate by the spin-coating technique. Spin-coating is a technique for forming a thin, uniform layer, by depositing a solution of the substance of the film, on the planar surface of a substrate that rotates at a high speed.

The manufacturing method according to the present invention advantageously comprises the following steps:
1—hot-dissolving, in an apolar aprotic solvent, a powder of single-chain magnets previously obtained by reaction between an organic ligand and a metal salt;
2—depositing the mixture, by spin-coating, on a solid substrate;
3—cooling the mixture to a temperature of 0 to 5° C.; and
4—allowing the mixture to return to room temperature.

The present invention also relates to an information storage device including at least one of the elements selected from:
at least one supramolecular nanotube as described previously in the context of the invention;
at least one metallogel as described previously in the context of the invention; and
at least one information storage material as described previously in the context of the invention.

The present invention is also described in the following detailed description, by means of the experimental part which details certain embodiments by means of examples, given only by way of illustration and which should not be considered as limiting.

### EXPERIMENTAL PART

Analytical grade solvents (methanol, chloroform, dichloromethane and n-heptane, etc.) and aldehydes (4-hexyl-, 4-decyl- and 4-octadecyloxybenzaldehyde) are commercially available and used without further purification.

### Experimental Analyses and Protocols

The FT-IR spectra were recorded with a Frontier UATR™ spectrophotometer from Perkin-Elmer® on the gels, solutions and powders (from 4000 to 550 cm-1, with a resolution of 1 cm-1).

The UV-visible absorption spectra of the solutions and gels were recorded with a Jasco®-V670 spectrophotometer (from 800 to 350 nm, 400 nm·min-1, with a resolution of 1 nm) in a Hellma® 110-QS cuvette with an optical path of 1 mm.

The elemental analyses (CHNS) were carried out with an analyzer of the FlashEA 1112 series sold by Thermo Fischer Scientific®.

The X-ray powder diffraction patterns were collected with a Panalytical® X'pert Pro™ diffractometer equipped with an X'Celerator® detector (45 kV, 40 mA for CuKα, λ=1.542 Å, mode 8/8). The simulated diagrams were calculated with the Mercury program of the CCDC.

The fresh single crystals were mounted on a Bruker® diffractometer of the D8 Venture™ series equipped with a CMOS PHOTON 100™ detector. The crystal data were collected with MoKα radiation (λ=0.70713 Å) at 150K. The crystalline structures were resolved by means of SHELXT1 and refined with full-matrix least squares methods based on F2 (SHELXL)2 running the WINGX3 program. All the non-hydrogen atoms were refined with anisotropic atomic displacement parameters, and the H atoms were finally included in their positions calculated and treated as being straddling their parent atom with constrained thermal parameters.

The gelation properties were evaluated by introducing a precise amount of the targeted compound and a volume of solvent necessary to reach the required mass concentration. The flask was closed and heated with a heat gun until complete dissolution of the compound and homogenization of the solution. The solution was cooled to 4° C. for several minutes or hours, depending on the gelation dynamics of the compound and the concentration.

The magnetic studies were carried out using a SQUID (Superconductive Quantum Interference Device) type magnetometer of the MPMS series marketed by the company Quantum Design® equipped with an RSO probe. The ground powder of the precursors is pressed into pellets to avoid the orientation of the crystallites in the field. The fresh gels are transferred into gelatin capsules, and frozen at 100K (the freezing point of n-heptane being 182K) to avoid any additional degradation. The measurements of the powder were corrected for the diamagnetic contributions calculated with the Pascal constants, and the measurements of the gel were corrected by subtracting the diamagnetic contributions of the tube, the Teflon, the fat and the solvent measured under the same conditions. The data were adjusted with the MagSuite V.2.5™ software [ref. 29].

### Synthesis and Gelation Properties

Syntheses of the Ligands Having the Nitronyl-Nitroxide Radicals (NIT) NITPhOCₙ (n=6, 10, 18)

The NITPhOCₙH₂ₙ₊₁ ligands described in the context of the present description will be denoted in the rest of the description without specifying the number of hydrogen atoms of the linear carbon chain, instead specifying only the number n of carbon atoms: NITPhOCₙ.

NITPhOC₆: 486 μL (2.5 mmol, 1 eq.) of 4-(hexyloxy)benzaldehyde (CAS: 5736-94-7) are added to 741 mg (5 mmol, 2 eq.) of 2,3-bis(hydroxyamino)-2,3-dimethylbutane in methanol (50 mL), and stirred at room temperature for 1 day. The solution is dried and the remaining milky white waxy solid is dissolved in 100 mL of CH₂Cl₂, mixed with an aqueous solution (100 mL) of NaIO₄ (641.6 mg, 3 mmol, 1.5 eq.). The mixture immediately turns dark blue, the organic phase is washed several times with water (5×100 mL) and separated. The resulting solution is concentrated and purified by flash chromatography on a column of silica gel (40-60 μm, 60 Å) eluted with a mixed solution of ether/n-pentane 3/1. A dark-blue fraction is collected and concentrated under reduced pressure, to obtain 149.1 mg (0.448 mmol) of a blue crystalline solid.

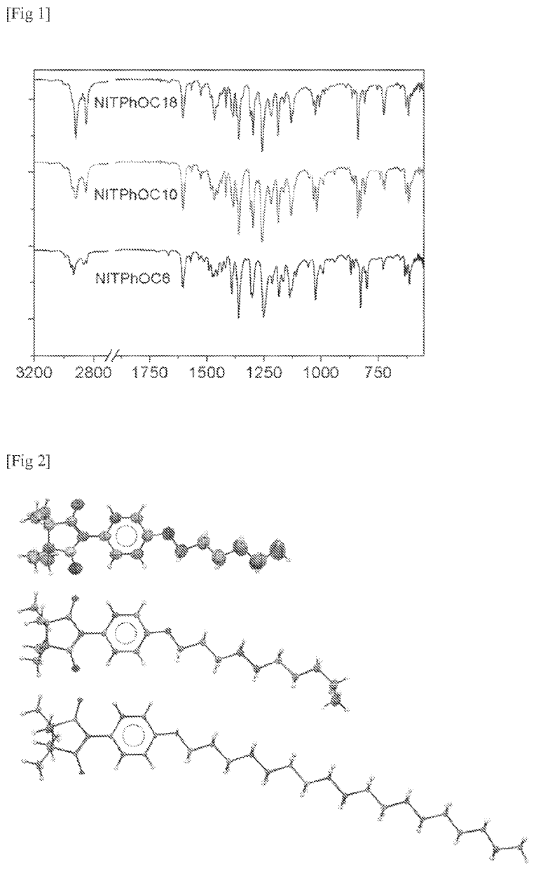

The same experimental protocol was rigorously reproduced for the synthesis of NITPhOC₁₀ (from 4-(decyloxy)benzaldehyde—CAS: 24083-16-7) and NITPhOC₁₈ (from 4-(octadecyloxy)benzaldehyde—CAS: 4105-95-7), leading to deep-blue crystalline powders and FT-IR signatures similar to that obtained for NITPhOC₆ [ref. 16]: see FIG. 1, showing a spectrogram with the transmission percentage on the Y-axis and the wavelength on the X-axis in cm⁻¹. Single crystals adapted to X-ray diffraction were obtained by slow layer diffusion of 7 mL of n-heptane on a layer of 0.05 mmol of radical in 10 mL of dichloromethane (DCM), stored at 4° C. for a few days.

NITPhOC₁₀ or (2-(4′-(decyloxy)phenyl)-4,4,5,5-tetramethylimidazoline-1-oxyl-3-oxide); yield: 36%. Calcined elemental analysis (%) for C₂₃H₃₇N₂O₃: C, 70.91; H, 9.57; N, 7.19. Found: C, 71.37; H, 9.59; N, 7.29.

NITPhOC₁₈ or (2-(4′-(octadecyloxy)phenyl)-4,4,5,5-tetramethylimidazoline-1-oxyl-3-oxide); yield: 25%. Calcined elemental analysis (%) for C₃₁H₅₃N₂O₃: C, 74.20; H, 10.65; N, 5.58. Found: C, 74.55; H, 10.51; N, 5.54.

The crystallographic data are reported in table 1:

TABLE 1

| Name | NITPhOC₁₀ | NITPhOC₁₈ |
|---|---|---|
| M (g · mol⁻¹) | 389.54 | 501.75 |
| Crystalline system | Monoclinic | Monoclinic |
| Space group | P2₁/c (no. 14) | P2₁/n (no. 14) |
| a (Å) | 8.4606(8) | 7.4068(13) |
| b (Å) | 31.157(3) | 44.744(8) |
| c (Å) | 9.0987(9) | 8.8243(17) |
| (alpha)α [°] | 90 | 90 |
| (beta)β [°] | 111.456(4) | 94.435(7) |
| (gamma)γ [°] | 90 | 90 |
| V [Å³] | 2232.3(4) | 2915.7(9) |
| Z | 4 | 4 |
| T (K) | 150 | 150 |
| range 2θ | 2.492-27.513 | 2.359-27.216 |
| Collected reflections | 5088 | 9894 |
| Independent reflections | 5088 | 6097 |
| Observed reflections | 4200 | 3869 |
| Numbers of parameters | 253 | 325 |
| R₁^{a} [I > 2σ(I)]/ | 7.75/20.69 | 17.88/46.94 |
| wR₂^{b} [I > 2σ(I)] | | |
| Adjustment agreement | 0.880 | 1.769 |
| factors | | |
| CCDC reference | — | — |

$$\sum ( \vert {F}_{0} \vert - \vert {F}_{c} \vert ) / \sum \vert {F}_{0} \vert \qquad [ Math 1 ] formula of a :$$

$$\sqrt{\sum {w ( \vert {F}_{0} {\vert}^{2} - \vert {F}_{c} {\vert}^{2} )}^{2} / \sum {w ( \vert {F}_{0} {\vert}^{2} )}^{2}} \qquad [ Math 2 ] formula of b :$$

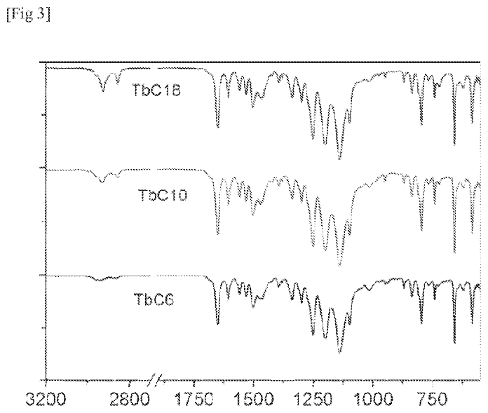

FIG. 2 gives the structural representations obtained after studying by X-ray diffraction the three ligands comprising the nitronyl-nitroxide radical (NIT) which is represented previously in the description in the diagram [chem 2]: NITPhOC₆H₁₃ (top), NITPhOC₁₀H₂₁ (middle) and NITPhOC₁₈H₃₇ (bottom, thermal ellipsoids with a probability of 50%). As specified above, these ligands are designated without specifying the number of hydrogen atoms of the linear carbon chain, instead specifying only the number n of carbon atoms; NITPhOCₙ.

Synthesis of Xerogels/Precursors of TbCn (n=6, 10, 18)

In the context of the present invention, the compounds denoted by the formula [Tb(hfac)₃(NITPhOCₙ)]m (n=6, 10, 18) are obtained by equimolar reaction between [Tb(hfac)₃·2H₂O] (hfac⁻=1,1,1,5,5,5-hexafluoroacetylacetonate) and NITPhOCₙ. In the context of the present invention, the three coordination polymers obtained [Tb(hfac)₃(NITPhOCₙ)]ₘ (n=6, 10, 18) will also be denoted in a more contracted manner, indicating only the metal atom and the number of carbons in the linear chain of the elemental subunits of the coordination polymer: TbCₙ (n=6, 10, 18). The index m being the number of elementary units in the coordination polymer, having a value considered as infinite. 0.05 mmol (1 eq.) of [Tb(hfac)₃·2H₂O] is dissolved in 40 mL of boiling dry n-heptane. The solution is concentrated until the volume reaches 10 mL, then cooled to 75° C. 0.05 mmol (1 eq.) of NITPhOCₙ (n=6, 10, 18) is dissolved in 3 mL of CHCl₃ and slowly added to the solution of n-heptane, and the mixture is allowed to return to room temperature and then evaporated under reduced pressure at room temperature, producing a dark-green powder for TbC₆ and TbC₁₀, and an elastic dark-green solid for TbC₁₃.

### Deposition on Solid Surface: A Silica Substrate

The forming of thin films of gels was carried out on silica substrates cleaned by sonication in a solution of 99.9% ethanol (Si/Cz <100> n-doped, 2-5 Ω·cm, Virginia Semiconductors™). Gels of TbC₆, TbC₁₀ and TbC₁₈ were formed by dissolving in n-heptane a powder formed under the conditions detailed hereinbefore at a concentration of 2 mg/mL.

The flask was closed and heated with a heat gun until complete dissolution of the compound and homogenization of the solution. 10 μL of this homogenized solution were deposited and underwent treatment by spin-coating at 2000 rpm for 60 s. The fresh samples were then placed in a refrigerator at 4° C. for 2 min in order to allow gelation on the substrate, then dried under a stream of dry N₂. The film obtained is then stable at room temperature.

Atomic force microscopy (AFM) studies were carried out on thin films of gels on fresh substrates and mounted on the support of the AFM sample. The samples were measured in semi-contact mode to avoid the deterioration of the soft film, with an SPM Solver P47 Pro (NT-MDT Spectrum Instrument™) and HQ:NSC36/Al BS silicon tips (cantilever B, 130 kHz, 2 N·m-1, MikroMasch™). The results and the images were processed with the Gwyddion v2.56 software [ref. 30].

### Analysis by Infrared Spectrometry

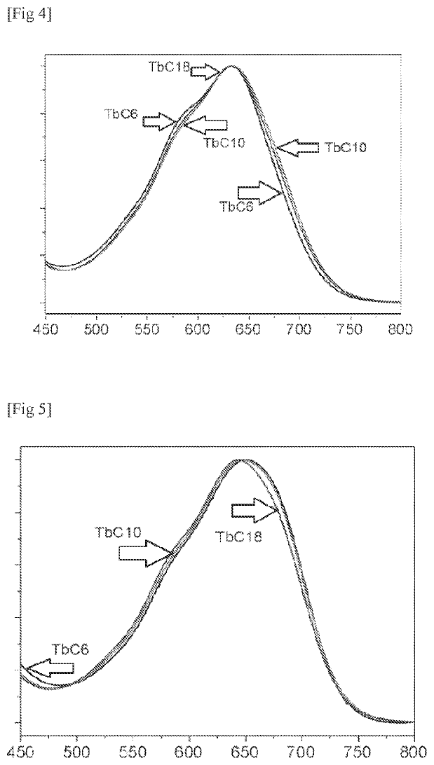

FIG. 3 shows the FT-IR signatures obtained for the three xerogels of TbCₙ (n=6, 10, 18): the spectrogram should be read with the transmission percentage on the Y-axis and the wavelength on the X-axis in cm⁻¹.

### Analysis by UV-Visible Spectrometry

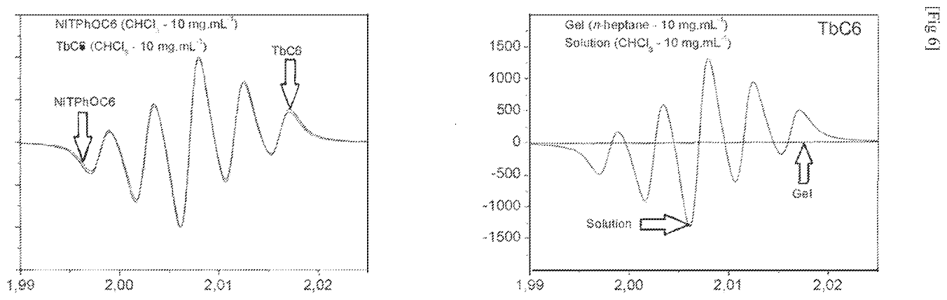

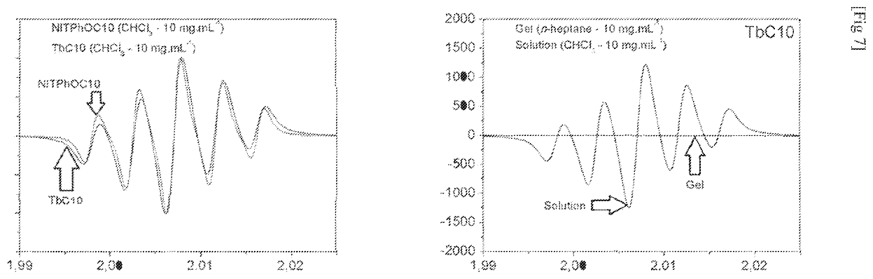

FIG. 4 and FIG. 5 show the UV-visible spectra in n-heptane, for a mass concentration of 10 mg·mL⁻¹ (normalized absorbance as a function of the wavelength λ in nm) of the solutions heated to 70° C. (FIG. 4) and of the gels at 4° C. (FIG. 5) of the three TbCₙ complexes (n=6, 10, 18).

A significant color change is associated with the thermoreversible sol-gel transition, from a deep-blue solution to a translucent cyan gel. This transition is confirmed by the UV-visible absorption measurements and is characterized by a displacement of 10-20 nm toward higher wavelengths of the main absorption band, from 633-634 nm for the solutions to 643-650 nm for the gels.

### EPR Analysis

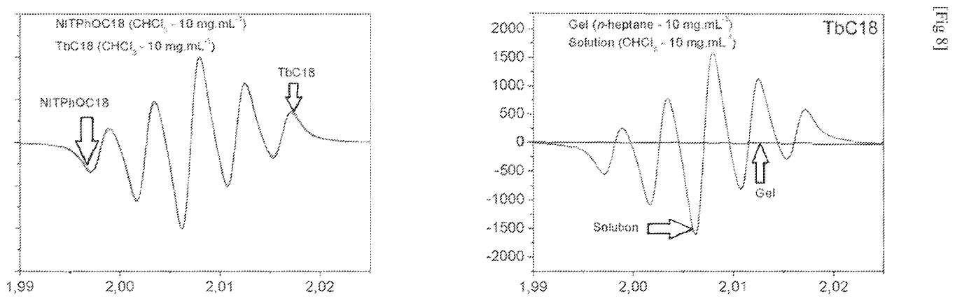

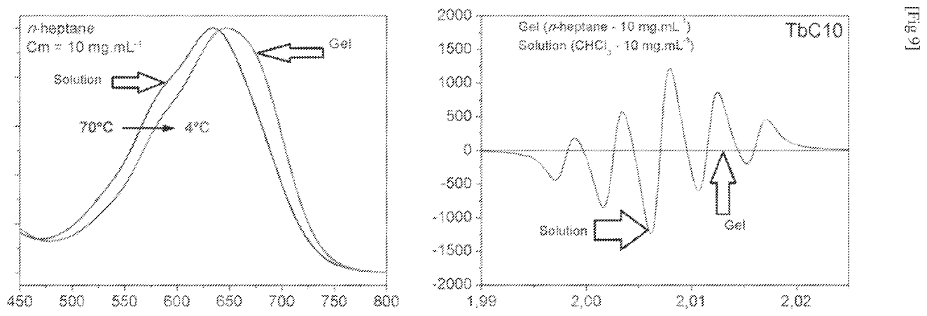

FIG. 6, FIG. 7 and FIG. 8 show the EPR spectrograms recorded on an Elexsys® E500 X-band CW X-band spectrometer (electronic magnetic resonance, the spectra represent the normalized intensity on the Y-axis as a function of the Landé g-factor (dimensionless) on the X-axis).

Table 2 reports gₑ field values and an hyperfine coupling values for the three terbium complexes:

TABLE 2

| | NITCₙ (10 mg · mL⁻¹, | | TbCₙ (10 mg · mL⁻¹, | | TbCₙ (10 mg · mL⁻¹, | |
|---|---|---|---|---|---|---|
| | CHCl₃) | | CHCl₃) | | n-heptane) | |
| n | gₑ | aₙ (mT) | gₑ | aₙ (mT) | gₑ | aₙ (mT) |
| 6 | 2.0071 | 0.76 | 2.0070 | 0.77 | 2.0072 | 0.75 |
| 10 | 2.0071 | 0.76 | 2.0071 | 0.77 | 2.0072 | 0.75 |
| 18 | 2.0071 | 0.76 | 2.0071 | 0.77 | 2.0073 | 0.76 |

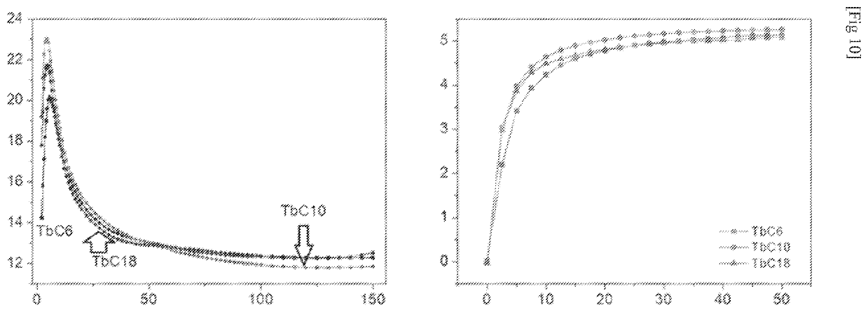

In FIG. 9 for the TbC₁₀ complex, the UV (normalized absorbance as a function of the wavelength λ in nm) and EPR (normalized intensity on the Y-axis as a function of the Landé g-factor (dimensionless) factor on the X-axis) spectrograms are shown both for the solution at 70° C. and the gel at 4° C. on the same UV spectra (on the left).

Since nitroxide radicals are highly sensitive to EPR, they are used as spin markers to track the assembly and gelation dynamics of modified organogels [ref. 20-24].

The X-band EPR signals of the solutions and the gels of TbCₙ were recorded at room temperature, having spectra with five lines (due to the hyperfine coupling between the two equivalent nitrogen atoms). The values of factor gₑ and aₙ (see figures and table 3) are consistent with those found in the literature for the non-coupled/free NIT radicals. However, the strong decrease in the relative peak intensity between the spectra of the CHCl₃ solution and the gel indicates a strong loss of the contribution/mobility of free radicals due to the formation of a coordinated network. It can be noted that a small contribution of non-coordinated (so-called free) NIT radicals was measured in the gels, which testifies to the good homogeneity of the gels and to the good quality of the coordination between the metal ions and the NIT radicals.

### Gelation

The gelation properties were evaluated with respect to various common solvents and summarized in table 3 hereunder, which gives the minimum gelation concentration (MGC, in mg·mL⁻¹) of TbC₆, TbC₁₀ and TbC₁₈ (S=solution, I=insoluble).

TABLE 3

| Solvent | TbC₆ | TbC₁₀ | TbC₁₈ |
|---|---|---|---|
| n-hexane | 10 | 10 | 10 |
| n-heptane | 8 | 7 | 8 |
| n-octane | 8 | 6 | 8 |
| n-decane | 10 | 4 | 5 |
| Cyclohexane | S | S | S |
| Xylenes | S | S | S |
| Toluene | S | S | S |
| Ether | S | S | S |
| Chloroform, DCM | S | S | S |
| Acetone | S | S | S |
| Acetonitrile | S | S | S |
| Methanol, ethanol | S | S | S |
| Water | I | I | I |

Only the linear aliphatic solvents allowed effective gelation of the compounds, the best gelation capacity for the series TbC₆, TbC₁₀, TbC₁₈ being attributed to n-heptane. Among the solvents listed in table 3, with the exception of n-heptane, the solvents compete with the formation of coordination bonds by solubilization and/or excessive solvation of the building blocks and probably prevent the formation of a π-stacking pattern between the aromatic hfac⁻ and the NIT phenyl fragments. A low-temperature quenching step, by placing the mixture containing the single-chain magnets of TbCₙ in the refrigerator (4° C. and atmospheric pressure), is a condition necessary for the formation of the supramolecular nanotubes from the solution and thus for obtaining the gels. The gelation capacity of the NIT radicals alone was tested in the same way but they were not able to produce gels, which emphasizes the importance of the complex having Tb(hfac)₃ in the self-assembling process as a “bonding node” between the organogelators during the self-aggregation process.

### Static Magnetic Properties

The static magnetic properties (DC) were measured on fresh gels frozen under a static field (H_{DC}=1000 Oe). The temperature dependence of the product χ_{M}T shows similar behavior between the gels TbC₆, TbC₁₀ and TbC₁₃, with respective χ_{M}T (150K) values of 12.28, 11.85 and 12.52 emu·K·mol⁻¹ (emu, electromagnetic units). These values are close to the theoretical χ_{M}T values of 12.195 emu·K·mol⁻¹ for a free Tb(III) ion (J=6, gJ=3/2) and an uncoupled radical (S=½, gS=2). By decreasing the temperature, these values remain constant and then increase exponentially below 100K, reaching maxima of 20.18 emu·K·mol⁻¹ at 5.5K (TbC₆), 23.03 and 21.73 emu·K·mol⁻¹ at 4.5K (for TbC₁₀ and TbC₁₃, respectively), followed by a strong decrease due to the effects of saturation. This low-T exponential divergence is the signature of the growth of a correlation length along the single-chain magnets (SCMs), such that χ_{M}T=C_{eff}·exp(Δξ/kBT) with C_{eff} the effective Curie constant, k_{B} the Boltzmann constant, and Δξ the correlation energy. Additionally the dependency of the magnetization with respect to the field has an abrupt increase beginning with the weakest fields and quickly reaching saturation values Mₛₐₜ of 5.2, 5.26 and 5.1 μB (for TbC₆, TbC₁₀ and TbC₁₃, respectively), slightly less than the theoretical value of 5.5 μB, and taking into account the ferri- and ferromagnetic interactions between the Tb(III) ions.

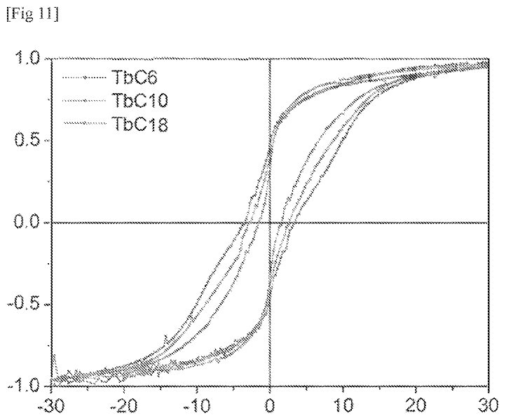

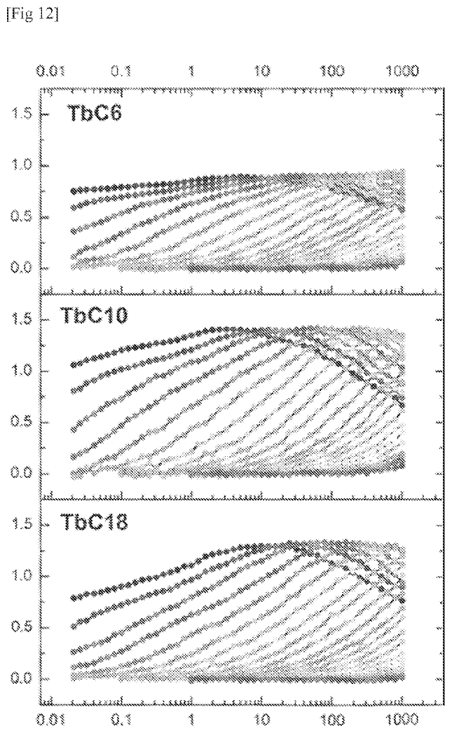

The hysteresis measurements at low temperature (0.5K) show the presence of magnetic hysteresis for gels of TbC₆, TbC₁₀ and TbC₁₈ and coercive fields H_{c} of 3350, 2650 and 1570 Oe, respectively. The measurements obtained are reported in FIG. 10: (on the right) on the Y-axis the magnetization M in μ_{B} (Bohr magneton, with 1 N_{A}·μ_{B}=5,585 cm3·Oe·mol-1, N_{A} is Avogadro's number) as a function of the intensity of the magnetic field H in kiloOersted (kOe) reported on the X-axis,
(on the left) on the Y-axis the temperature dependence of the product of the molar susceptibility and of the temperature χ_{M}T in emu·K·mol⁻¹ as a function of the temperature in Kelvin (K) reported on the X-axis;
and in FIG. 11: on the Y-axis the normalized magnetization M in μ_{B} as a function of the intensity of the magnetic field H in kiloOersted (kOe) reported on the X-axis.

### Dynamic Magnetic Properties

The magnetic relaxation behavior of the gels was probed by AC susceptibility measurements with a weak magnetic field (H_{AC}=3 Oe) oscillating between v=0.01 and 1000 Hz, and in the absence of a static external field H_{DC}. In-phase susceptibility (χ_{M}′) and out-of-phase susceptibility (χ_{M}″) have a noisy but unambiguous frequency dependency below 6K. The measurements obtained are reported in FIG. 12 (with the frequency v in Hz on the X-axis of FIG. 12; and the out-of-phase susceptibility χ_{M}″ in emu·mol⁻¹ on the Y-axis)

The characteristic relaxation times T were deduced using a generalized Debye model and adjusted via an Arhhenius law τ=τ₀·exp (Δ_{eff}/k_{B}T), Δeff being the effective energy barrier.

### REFERENCES

The following table lists the references cited previously in the text:

TABLE 4

| | |
|---|---|
| 1 | F. Fages, Angew. Chem. Int. Ed. 2006, 45, 1680-1682 |
| 2 | A. Y.-Y. Tam, V. W.-W. Yam, Chem. Soc. Rev. 2013, 42, 1540 |
| 3 | H. Wu, J. Zheng, A. Kjøniksen, W. Wang, Y. Zhang, J. Ma, Adv. Mater. 2019, |
| | 31, 1806204 |
| 4 | C. D. Jones, J. W. Steed, Chem. Soc. Rev. 2016, 45, 6546-6596 |
| 5 | M.-O. M. Piepenbrock, G. O. Lloyd, N. Clarke, J. W. Steed, Chem. Rev. |
| | 2010, 110, 1960-2004 |
| 6 | S. Bhowmik, S. Banerjee, U. Maitra, Chem. Commun. 2010, 46, 8642 |
| 7 | P. Chen, Q. Li, S. Grindy, N. Holten-Andersen, J. Am. Chem. Soc. 2015, |
| | 137, 11590-11593 |
| 8 | H. Kim, J. Young Chang, RSC Adv. 2013, 3, 1774-1780 |
| 9 | J. Y. R. Silva, L. L. da Luz, F. G. M. Mauricio, I. B. Vasconcelos Alves, J. N. |
| | de S. Ferro, E. Barreto, I. T. Weber, W. M. de Azevedo, S. A. Júnior, |
| | ACS Appl. Mater. Interfaces 2017, 9, 16458-16465 |
| 10 | M. Martinez-Calvo, O. Kotova, M. E. Möbius, A. P. Bell, T. McCabe, J. J. |
| | Boland, T. Gunnlaugsson, J. Am. Chem. Soc. 2015, 137, 1983-1992 |
| 11 | M. X. Wang, C. H. Yang, Z. Q. Liu, J. Zhou, F. Xu, Z. Suo, J. H. Yang, Y. M. |
| | Chen, Macromol. Rapid Common. 2015, 36, 465-471 |
| 12 | M. Häring, D. D. Diaz, Chem. Commun. 2016, 52, 13068-13081 |
| 13 | C. Kim, K. Y. Kim, J. H. Lee, J. Ahn, K. Sakurai, S. S. Lee, J. H. Jung, |
| | ACS Appl. Mater. Interfaces 2017, 9, 3799-3807 |
| 14 | T. Singha Mahapatra, H. Singh, A. Maity, A. Dey, S. K. Pramanik, E. Suresh, |
| | A. Das, J. Mater. Chem. C 2018, 6, 9756-9766 |
| 15 | F. Chen, Y.-M. Wang, W. Guo, X.-B. Yin, Chem. Sci. 2019, 10, 1644-1650 |
| 16 | F. Houard, Q. Evrard, G. Calvez, Y. Suffren, C. Daiguebonne, O. Guillou, F. |
| | Gendron, B. Le Guennic, T. Guizouarn, V. Dorcet, M. Mannini, K. Bernot, |
| | Angew. Chem. Int. Ed. 2020, 59, 780-784 |
| 17 | A. Caneschi, D. Gatteschi, J. Laugier, P. Rey, R. Sessoli, C. Zanchini, |
| | J. Am. Chem. Soc. 1988, 110, 2795-2799 |
| 18 | A. Caneschi, D. Gatteschi, N. Lalioti, C. Sangregorio, R. Sessoli, G. Venturi, |
| | A. Vindigni, A. Rettori, M. G. Pini, M. A. Novak, Angew. Chem. Int. Ed. 2001, |
| | 40, 1760-1763 |
| 19 | X. Meng, W. Shi, P. Cheng, Coordination Chemistry Reviews 2019, 378, |
| | 134-150 |
| 20 | P. Terech, R. Ramasseul, F. Volino, Journal of Colloid and Interface Science |
| | 1983, 91, 280-282 |
| 21 | P. Terech, Journal of Colloid and Interface Science 1985, 107, 244-255 |
| 22 | M. Kveder, M. Andreis, J. Makarević, M. Jokić, B. Rakvin, |
| | Chemical Physics Letters 2006, 420, 443-447 |
| 23 | M. Mannini, S. Cicchi, D. Berti, A. Caneschi, A. Brandi, L. Lascialfari, L. |
| | Sorace, ChemPlusChem 2013, 78, 149-156 |
| 24 | Y. Takemoto, T. Yamamoto, N. Ikuma, Y. Uchida, K. Suzuki, S. Shimono, H. |
| | Takahashi, N. Sato, Y. Oba, R. Inoue, M. Sugiyama, H. Tsue, T. Kato, J. |
| | Yamauchi, R. Tamura, Soft Matter 2015, 11, 5563-5570 |
| 25 | P. Hu, Z. Sun, X. Wang, L. Li, D. Liao, D Luneau, New J. Chem., 2014, 38, |
| | 4716-4721 |
| 26 | Murakami, R., Nakamura, T., and Ishida, T., Dalton Trans. 2014, 43, 5893 |
| 27 | Murakami, R., Ishida, T., Yoshii, S., and Nojiri, H., Dalton Trans. 2013, 42, |
| | 13968 |
| 28 | Kanetomo, T. and Ishida, T., Inorg. Chem. 2014, 53, 10794 |
| 29 | Mathieu, R. MagSuite_{—}V2.5; Zenodo, 2021. |
| | https://doi.org/10.5281/ZENODO.4030310. |
| 30 | Nečas, D.; Klapetek, P. Gwyddion: An Open-Source Software for SPM Data |
| | Analysis. Open Phys. 2012, 10 (1), 181-188. |
| | https://doi.org/10.2478/s11534-011-0096-2 |

1. A supramolecular nanotube comprising at least one single-chain magnet including a coordination polymer, said coordination polymer comprising at least one linear macromolecular chain comprising repeating units containing at least one metal, said metal being coordinated by at least one ligand comprising at least one linear carbon chain, said linear carbon chain comprises 9 to 27 carbons.

2. The supramolecular nanotube according to claim 1, wherein the linear carbon chain comprises 12 to 24 carbons.

3. The supramolecular nanotube according to claim 1, wherein the metal of the linear macromolecular chain is a chemical element selected from the transition metal family.

4. The supramolecular nanotube according to claim 1, wherein the metal of the linear macromolecular chain is selected from at least one of the seventeen elements belonging to the rare earth family, i.e. selected from Sc, Y, Lu, La, Ce, Pr, Nd, Pm, Sm, Eu, Gd, Tb, Dy, Ho, Er, Tm and Yb, preferably terbium Tb.

5. The supramolecular nanotube according to claim 1, wherein the supramolecular nanotube comprises at least seven single-chain magnets, preferably the supramolecular nanotube comprises at least ten single-chain magnets.

6. The supramolecular nanotube according to claim 1, wherein at least one ligand of the single-chain magnet comprises a radical group, preferably the ligand of the single-chain magnet is a radical ligand selected from an N-radical ligand and an O-radical ligand.

7. The supramolecular nanotube according to claim 6, wherein the radical ligand comprises the nitronyl-nitroxide radical referred to as NIT.

8. The supramolecular nanotube according to claim 1, wherein the ligand includes an aromatic group substituted by the linear carbon chain and by an NIT radical, and the aromatic group is preferably a phenoxy group (PhO−).

9. A metallogel including a gel comprising supramolecular nanotubes according to claim 1, wherein the nanotubes include molecules of an apolar aprotic organic solvent, preferably a linear aliphatic solvent, the solvent preferably being selected from at least n-hexane, n-heptane, n-octane and n-decane, preferably n-heptane.

10. The metallogel according to claim 9, wherein the gel is obtained from a solution comprising the supramolecular nanotubes dissolved in the apolar aprotic solvent and cooled until reaching a temperature of between 0 and 5° C., maintaining this temperature for at least one minute.

11. An information storage material comprising a substrate covered with a metallogel according to claim 9.

12. A method for manufacturing the information storage material according to claim 11, including a step of depositing the metallogel on the substrate by the spin-coating technique.

13. The manufacturing method according to claim 12, comprising the following steps:
1—hot-dissolving, in an apolar aprotic solvent, a mixture including single-chain magnets previously obtained by reaction between an organic ligand and a metal salt;
2—depositing the mixture, by spin-coating, on a solid substrate;
3—cooling the mixture to a temperature of 0 to 5° C.; and
4—allowing the mixture to return to room temperature.

14. An information storage device including at least one supramolecular nanotube according to claim 1.
